(19) United States
(12) Patent Application Publication
(10) Pub. No.: US 2012/0114873 A1
(43) Pub. Date: May 10, 2012

(54) PROCESS OF PRODUCING AN OPTICAL FILM

(76) Inventors: Takatoshi Yosomiya, Tokyo (JP); Kazuaki Watanabe, Tokyo (JP)

(21) Appl. No.: 13/253,250

(22) Filed: Oct. 5, 2011

(30) Foreign Application Priority Data
Nov. 10, 2010 (JP) 2010-251973

(51) Int. Cl. B05D 5/06; B05D 3/06; B05D 3/10

(52) U.S. Cl. 427/536; 427/162; 427/553

(57) ABSTRACT

The present invention provides an optical film having a high transparency and an excellent adhesion property to polarizers. The process for producing an optical film according to the present invention includes a step (1) of subjecting at least one surface of a polypropylene resin base film to physical surface treatment; and a step (2) of applying a hydrophilic resin composition onto the physically treated surface of the polypropylene resin base film.

### FIELD OF THE INVENTION

The present invention relates to a process for producing optical members used in displays, and more particularly, to a process for producing optical films suitably used as protective films for polarizers or retardation films (phase difference films).

### BACKGROUND OF THE INVENTION

In recent years, various displays such as liquid crystal displays and organic electroluminescent (EL) displays have been extensively used in the applications such as TVs, computers and mobile phones. With the spread of the markets for these displays, it has been strongly required to further reduce a thickness of the displays and production costs therefor.

In FIG. 3, there is shown a construction of a liquid crystal display as an example of the above displays. The liquid crystal display shown in FIG. 3 includes a liquid crystal cell 8 and a polarizing plate 7 including a retardation (phase difference) film 9 which is disposed on one surface of the liquid crystal cell 8. The polarizing plate 7 includes a polarizer 6 which is disposed at a center thereof, and the retardation film 9 and a TAC film 5 as a protective film for the polarizer (polarizer-protective film) which are disposed on opposite surfaces of the polarizer 6.

The polarizing plate used in the above displays serves as an optical member capable of allowing one of light components to be polarized which are perpendicular in vibration direction to each other to transmit therethrough and preventing the other polarized light component from passing therethrough. The polarizing plate is generally constructed from a polarizer and a polarizer-protective film(s) disposed on one or both surfaces of the polarizer. The polarizer has a function capable of allowing only a light oriented in a specific vibration direction to transmit therethrough. As a material of the polarizer, there has been widely used a polyvinyl alcohol (hereinafter occasionally referred to merely as “PVA”)-based film in the form of a monoaxially stretched hydrophilic resin dyed with iodine or a dichromic dye.

In addition, the polarizer-protective film also has a function of supporting the polarizer to impart a practical strength to an entire part of the polarizing plate and physically protect a surface of the polarizer. Therefore, the polarizer-protective film is required to have various properties such as a practical strength, a high transparency and a low optical non-uniformity such as less occurrence of moire pattern. For this reason, the polarizer-protective film is generally formed of a cellulose triacetate (hereinafter occasionally referred to merely as “TAC”) film as a cellulose-based film.

The cellulose triacetate (TAC) film is usually first subjected to saponification treatment with an alkali (in which an ester group of TAC is converted into a hydroxyl group as a hydrophilic group), and then bonded to the polarizer formed from polyvinyl alcohol as a hydrophilic resin through a PVA-based adhesive called “aqueous glue”. As the technology for enhancing various properties required for the cellulose triacetate as described above, there have been proposed, for example, the methods in which a specific resin layer is formed on a cellulose triacetate layer (refer to Patent Documents 1 and 2). However, since cellulose triacetate (TAC) is very expensive, there is a demand for alternative materials which are inexpensive and have similar properties to those of TAC.

In the liquid crystal displays (hereinafter occasionally referred to merely as “LCD”), the polarizer-protective film which is disposed on an inside surface of LCD (on the side near to the liquid crystal cell) is strongly required to exhibit a specific birefringence in conformity with a mode of the liquid crystal. Therefore, various retardation films including not only the TAC films but also cycloolefin polymer (COP) films have been adopted as the above polarizer-protective film. On the other hand, the polarizer-protective film which is disposed on an outside surface of LCD (on the uppermost layer side remote from the liquid crystal cell) is required to have an outer surface exhibiting a hard coat property, and is therefore formed of a base material containing TAC as a main component. The polarizer-protective film which is disposed on the backlight side of LCD (on the lowermost layer side remote from the liquid crystal cell) is required to exhibit a high transparency as a more important factor rather than the birefringence. For this reason, it has been demanded to develop alternate materials of TAC. Further, the polarizer-protective film which is disposed on the side of a backlight using an ordinary fluorescent tube is also required to have an ultraviolet absorption property.

In the present invention, a generally used inexpensive polypropylene resin having a high transparency is employed as an alternate resin of TAC. However, it will be difficult to use an ordinary polypropylene resin as the alternate material of TAC because the polypropylene resin has no hydrophilic group and therefore exhibits as such no sufficient adhesion to a PVA-based adhesive used upon bonding it to PVA. In addition, the polypropylene resin usually exhibits a poor adhesion property to a coating material, and therefore is hardly usable as the alternate material of TAC even when coated with a separate hydrophilic resin capable of adhering to PVA. Thus, there is demand for development of a polarizer-protective film which is disposed on the side of an outer surface of LCD and is capable of adhering to the polarizer formed of polyvinyl alcohol.
Patent Document 1: JP 9-113728A
Patent Document 2: JP 9-281333A

### SUMMARY OF THE INVENTION

The present invention has been made to solve the above conventional problems. An object of the present invention is to provide a process for producing an optical film having a high transparency and excellent adhesion to polarizers.

As a result of intensive and extensive researches to achieve the above object, the inventors have found that the above problems can be solved by the below-mentioned invention. The subject matter of the present invention is as follows.

That is, in an aspect of the present invention, there is provided a process for producing an optical film including the following steps (1) and (2):

Step (1): subjecting at least one surface of a polypropylene resin base film to physical surface treatment; and

Step (2): applying a hydrophilic resin composition onto the physically treated surface of the polypropylene resin base film.

### EFFECT OF THE INVENTION

According to the production process of the present invention, it is possible to obtain an optical film having a high transparency and excellent adhesion to polarizers. In addition, a polarizing plate produced using the optical film obtained according to the production process of the present invention as a polarizer-protective film can exhibit an excellent strength and a good handling property, and a display obtained using the polarizing plate can stably exhibit desired properties for a long period of time.

### BRIEF DESCRIPTION OF THE DRAWINGS

FIG. 1 is a schematic sectional view of an optical film obtained according to the production process of the present invention.

FIG. 2 is a schematic sectional view of a polarizing plate (lower polarizing plate) in which the optical film of FIG. 1 obtained according to the production process of the present invention is used as a polarizer-protective film.

FIG. 3 is a schematic sectional view of a liquid crystal display in which the optical film of FIG. 1 obtained according to the production process of the present invention is used as a retardation film.

### EXPLANATION OF REFERENCE NUMERALS

1: Hydrophilic resin layer; 2: Modified surface; 3: Polypropylene resin base film; 4: Optical film obtained according to the production process of the present invention; 5: TAC film; 6: Polarizer; 7: Polarizing plate (lower polarizing plate); 8: Liquid crystal cell; 9: Retardation film; 10: Adhesive layer; 11: Tacking adhesive layer

### DETAILED DESCRIPTION OF THE INVENTION

### [Optical Film]

The process for producing an optical film according to the present invention includes the following steps (1) and (2):

Step (1): subjecting at least one surface of a polypropylene resin base film to physical surface treatment; and

Step (2): applying a hydrophilic resin composition onto the physically treated surface of the polypropylene resin base film.

First, the optical film obtained according to the production process of the present invention is explained while appropriately referring to the accompanying drawings. The optical film obtained according to the production process of the present invention includes a polypropylene resin base film and a hydrophilic resin layer laminated on at least one surface of the polypropylene resin base film, in which the surface of the polypropylene resin base film on which the hydrophilic resin layer is laminated is subjected to physical surface treatment.

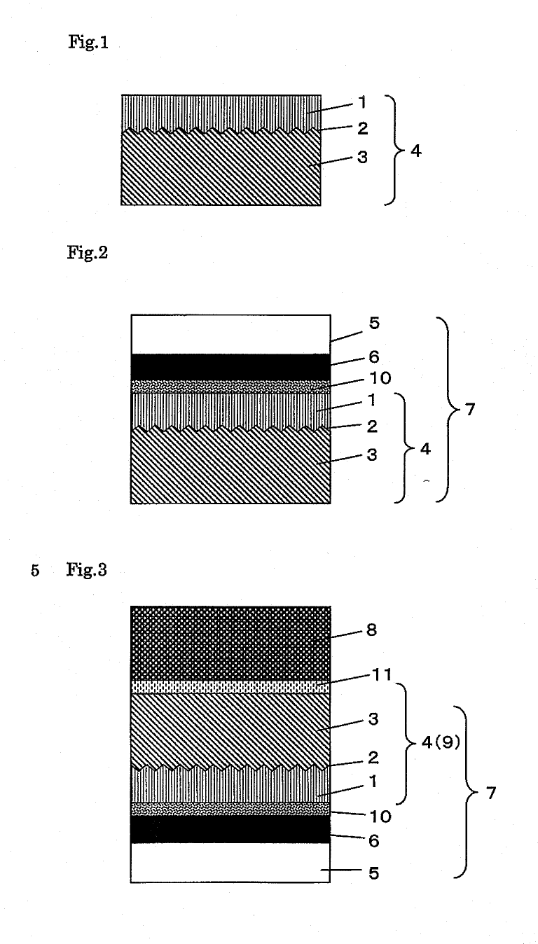

The optical film 4 obtained according to the production process of the present invention as shown in FIG. 1 includes the polypropylene resin base film 3 constituted from a polypropylene resin composition, and the hydrophilic resin layer 1. The surface of the base film 3 on which the hydrophilic resin layer 1 is provided is subjected to physical surface treatment to form a modified surface 2 thereof.

### <<Polypropylene Resin Base Film>>

The polypropylene resin base film 3 is formed from an inexpensive polypropylene resin having a high transparency. The polypropylene resin has not only a high transparency and inexpensiveness, but also an excellent impact strength, and therefore can be suitably used for protecting polarizers in liquid crystal displays (LCD). Further, the polypropylene resin may also be used as an alternate material of TAC and disposed on an outside of LCD.

The polypropylene resin used for the base film 3 is a resin having a skeleton derived from propylene. The polypropylene resin used in the present invention is not particularly limited, and examples of the polypropylene resin include propylene homopolymers, and copolymers of propylene with at least one monomer selected from the group consisting of ethylene and α-olefins having 4 to 18 carbon atoms. In addition, as the polypropylene resin, there may also be suitably used those polypropylenes produced by polymerization using a metallocene catalyst.

### <Polypropylenes Produced by Polymerization Using Metallocene Catalyst>

The polypropylenes produced by polymerization using a metallocene catalyst are in the form of a propylene polymer synthesized by the polymerization reaction using the below-mentioned metallocene catalyst. The polypropylenes produced by polymerization using the metallocene catalyst generally exhibit uniform molecular weight and crystallinity as compared to those produced by polymerization using a generally used Ziegler-Natta catalyst, and therefore contain a less amount of low-molecular weight or low-crystalline components. Thus, the optical film obtained from the polypropylenes produced by polymerization using the metallocene catalyst has a higher transparency than the optical film obtained from the polypropylenes produced by polymerization using the Ziegler-Natta catalyst. For this reason, in the present invention, the polypropylenes produced by polymerization using the metallocene catalyst are preferably used as the material of the base film.

The polypropylenes produced by polymerization using the metallocene catalyst may be in the form of either a propylene homopolymer or a copolymer of propylene with an α-olefin. From the viewpoint of good optical properties, among these polypropylenes, preferred are random copolymers of propylene with an α-olefin.

Examples of the preferred α-olefin include ethylene and 1-olefins having 4 to 18 carbon atoms. Specific examples of the preferred α-olefin include ethylene, 1-butene, 1-pentene, 1-hexene, 1-octene, 1-heptene, 4-methyl-pentene-1,4-methyl-hexene-1 and 4,4-dimethyl pentene-1. The proportion of propylene units in the copolymer is preferably not less than 80 mol % and less than 100 mol %, and the proportion of a comonomer or comonomers in the copolymer is more than 0 mol % and not more than 20 mol %, from the viewpoint of a good balance between a transparency and a heat resistance of the resulting polypropylene. Although only one kind of comonomer may be used in the copolymer, two or more kinds of comonomers may also be used in combination with each other therein, so that the resulting copolymer may be obtained in the form of a multi-component copolymer such as a terpolymer. Meanwhile, contents of constitutional units derived from the respective comonomers in the copolymer may be determined from the measurement of infrared (IR) absorption spectrum thereof.

### (Metallocene Catalyst)

As the metallocene catalyst, there may be appropriately used conventionally known metallocene catalysts. In general, there may be used organic transition metal compounds which contain a compound of a transition metal belonging to Groups 4 to 6 such as Zr, Ti and Hf, especially a compound of a Group 4 transition metal, and a cyclopentadienyl group or a cyclopentadienyl derivative group.

As the cyclopentadienyl derivative group, there may be used an alkyl-substituted cyclopentadienyl group such as a pentamethyl cyclopentadienyl group, or a cyclopentadienyl group constituting a saturated or unsaturated cyclic substituent group formed by bonding two or more substituent groups to each other. Typical examples of the cyclopentadienyl derivative group include an indenyl group, a fluorenyl group, an azulenyl group and partially hydrogenated products of these groups. Further suitable examples of the cyclopentadienyl derivative group include those groups formed by bonding a plurality of cyclopentadienyl groups through an alkylene group, a silylene group, a germylene group, etc.

### (Co-Catalyst)

Upon production of the polypropylene, the metallocene catalyst may be used together with a co-catalyst. As the co-catalyst, there may be used at least one compound selected from the group consisting of an aluminum-oxy compound, an ionic compound which is capable of reacting with a metallocene compound to convert the metallocene compound component into a cation, a Lewis acid, a solid acid and a phyllosilicate. In addition, an organic aluminum compound may be added together with these compounds, if required.

The above phyllosilicate means a silicate compound having a crystal structure in which constituting layers are stacked in parallel to each other with a weak bonding force such as ionic bonding force. The phyllosilicate used in the present invention preferably has an ion exchangeability. The ion exchangeability as used herein means that cations between the layers of the phyllosilicate are exchangeable with each other. Most of the phyllosilicates are mainly yielded as a main component of natural clay minerals. However, the phyllosilicate used in the present invention may be either natural products or synthesized products.

The phyllosilicate is not particularly limited, and any conventional known phyllosilicates may be used in the present invention. Specific examples of the phyllosilicate include kaolin groups such as dickite, nacrite, kaolinite, anorthite, metahalloysite and halloysite; serpentine groups such as chrysotile, lizardite and antigorite; smectite groups such as montmorillonite, sauconite, beidellite, nontronite, saponite, taeniolite, hectorite and stevensite; vermiculite groups such as vermiculite; mica groups such as mica, illite, sericite and glauconite; attapulgite; sepiolite; palygorskite; bentonite; pyrophyllite; talc; and chlorite groups. These phyllosilicates may form a mixed layer.

Among these phyllosilicates, preferred are smectite groups such as montmorillonite, sauconite, beidellite, nontronite, saponite, hectorite, stevensite, bentonite and taeniolite, vermiculite groups and mica groups.

These phyllosilicates may be subjected to chemical treatments. The chemical treatments as used herein may include both of surface treatments for removing impurities attached onto a surface of the phyllosilicates and treatments for modifying a crystal structure and a chemical composition of the phyllosilicates. Specific examples of these treatments include an acid treatment, an alkali treatment, a salt treatment and an organic substance treatment. These treatments are effective for removing impurities on a surface of the phyllosilicates, exchanging cations between the layers with each other, eluting cations such as Al, Fe and Mg in the crystal structure, or the like. As a result of carrying out these treatments, an ionic composite, a molecular composite or an organic derivative is formed to thereby vary a surface area, a distance between the layers, an acidity of the solid acid or the like. These treatments may be carried out alone or in combination of any two or more thereof.

### (Properties of Polypropylene and Base Film)

Examples of the method (polymerization method) for synthesizing polypropylene using the above metallocene catalyst include a slurry method in which the polymerization is carried out in an inert solvent in the presence of the catalyst, a gas phase method in which the polymerization is carried out using substantially no solvent, a solution method, and a bulk polymerization method in which a polymerizable monomer is used as a solvent.

The polypropylene thus obtained by these polymerization methods using the metallocene catalyst preferably has a melting point (Tm) of from 120 to 170° C. When the melting point (Tm) of the polypropylene lies within the above specified range, the optical film produced therefrom is enhanced in heat resistance, and therefore can be desirably used in the applications requiring a good heat resistance such as polarizing plates. The melting point may be determined from a temperature at which a maximum intensity peak is observed in a melting curve measured by a differential scanning calorimeter (DSC). More specifically, the melting point is the value determined from a melting peak temperature which may be observed and measured in the melting curve prepared by heat-treating 10 mg of a pressed film of a polypropylene-based copolymer in a nitrogen atmosphere at 230° C. for 5 min, cooling the film to 30° C. at a temperature drop rate of 10° C./min and holding the film at 30° C. for 5 min, and further heating the film from 30° C. to 230° C. at a temperature rise rate of 10° C./min.

The polypropylene resin base film 3 preferably has a flexural modulus of 700 MPa or higher. When the flexural modulus lies with the above specified range, the polypropylene resin base film can exhibit a sufficient rigidity upon handling it in a filmy state, resulting in facilitated post treatments thereof. Further, the retardation film preferably has a flexural modulus of 900 MPa or higher. In addition, the optical film produced using the base film preferably has a flexural modulus of 900 MPa or higher. The optical film having a flexural modulus of 900 MPa or higher can be stabilized with respect to in-plane retardation thereof when produced by T-die extrusion molding method. The flexural modulus as used herein may be measured according to JIS K7171.

The method of adjusting the flexural modulus is not particularly limited, and the following method may be used for adjusting the flexural modulus. For example, the flexural modulus of the polypropylene resin may be adjusted by the method in which properties inherent to the polypropylene resin (such as crystallinity and average molecular weight) are appropriately selected, the method in which a filler selected from inorganic and organic fillers is added to the resin, the method in which a crosslinking agent, etc., are added to the resin, the method in which two or more kinds of resins which are different in flexural modulus from each other are mixed, the method in which a plasticizer component for the curable resin is appropriately selected, etc. These methods may also be used by appropriately combining any two or more thereof.

The polypropylene resin base film 3 preferably has a tensile strength of 20 MPa or higher. When the tensile strength of the polypropylene resin base film is 20 MPa or higher, the optical film produced using the polypropylene resin base film is free from undesirable orientation when laminated to a polarizer through a PVA-based adhesive by a roll-to-roll method.

The thus obtained optical film tends to hardly suffer from variation in retardation thereof. Therefore, when using the optical film obtained according to the production process of the present invention as a retardation film, the polarizing plate produced using the retardation film can exhibit excellent properties, i.e., can be imparted with a good positive A-plate characteristic and a good negative C-plate characteristic. The tensile strength as used in the present invention may be measured according to ASTM D638 (conditions of Type 4).

The polypropylene resin base film 3 preferably has a melt flow rate (hereinafter occasionally referred to merely as “MFR”) of from 0.5 to 50 g/10 min, and more preferably 7 g/10 min or more. The MFR as used herein may be the value as measured at 230° C. under a load of 21.18 N according to JIS K7210. When the MFR of the optical film lies within the above specified range, it is possible to form an unstretched film while suppressing occurrence of distortion therein, thereby enabling design of a desirable retardation film. The resulting optical film can exhibit a sufficient strength, resulting in facilitated post treatments thereof. In addition, MFR of respective films in a production lot can be readily stabilized, resulting in stable molding procedure therefor. Further, since the amount of additives added to the film such as MFR modifiers can be reduced, properties of the resulting film are prevented from being adversely affected. Meanwhile, the MFR of the polypropylene may be controlled, for example, by adding a general MFR modifier such as an organic peroxide thereto.

The thickness of the polypropylene resin base film 3 is preferably in the range of from 10 to 200 μm and more preferably from 30 to 150 μm. When the thickness of the base film 3 is 10 μm or more, the resulting optical film can ensure good strength and rigidity. Whereas, when the thickness of the base film 3 is 200 μm or less, the resulting optical film can exhibit a sufficient flexibility and has a reduced weight, resulting in facilitated handling and advantageously low production costs. Further, the base film 3 having a thickness of the above specified range can exhibit a good handling property when forming the below-mentioned hydrophilic resin layer 1 thereon. On the other hand, by using the base film 3 having a thickness of 200 μm or less, it is possible to enhance a line speed, productivity, controllability, etc., upon production of the optical film.

The polypropylene resin base film 3 usually has an average surface roughness (Ra) of from 0.02 to 2, preferably from 0.07 to 2 and more preferably from 0.1 to 1. By controlling the average surface roughness (Ra) of the polypropylene resin base film 3 to the above specified range, the base film 3 is free from occurrence of flaws when subjecting a raw film thereof as produced to various treatments, and therefore can be enhanced in handling property. Also, in the optical, film in which the base film 3 is disposed as a lowermost layer, the base film can be effectively prevented from being stuck to the other layers. The average surface roughness (Ra) of the polypropylene resin base film 3 can be suitably controlled according to the molding method used for production of the base film. For example, when the base film 3 is formed by a T-die extrusion molding method, the surface condition of the base film may be controlled by using a mirror roll as a touch roll, whereas when the base film 3 is formed by a water-cooling inflation molding method, the surface condition of the base film may be controlled by applying a uniform pressure of a cooling water thereto.

In general, when the raw film as produced is taken up into a roll, the film must be subjected to embossing treatment (knurling treatment) at both ends in the width direction thereof to prevent blocking between overlapped portions thereof. The both end portions of the film which have been subjected to knurling treatment become unusable and therefore must be trimmed and disposed of. Further, when taking up the film, a protective film may be further provided thereover as a masking film to prevent occurrence of flaws thereon. However, in the present invention, since the base film 3 is constituted from the polypropylene resin and the average surface roughness (Ra) of the base film is adjusted to the above specified range, it is possible to prevent the film from suffering from blocking without being subjected to knurling treatment.

The polypropylene resin has a poor adhesion property to the hydrophilic resin layer 1 and therefore is free from risk of occurrence of blocking. For this reason, in the present invention, the production process of the optical film can be simplified, and the both end portions of the film in the width direction thereof become still usable. Further, the film having a much larger length can be taken up into a roll without failure of the film. In addition, the base film 3 having an adequate surface roughness can be effectively prevented from suffering from occurrence of flaws upon taking up, and it is not necessary to provide a masking over the film.

Meanwhile, the base film 3 may be subjected to matting treatment, if required.

When the optical film obtained according to the production process of the present invention is used as a polarizer-protective film, the base film 3 used therein preferably has an in-plane retardation Re of 20 nm or less and more preferably 10 nm or less. When the polarizer-protective film is provided with the base film 3 having such a low birefringence, light transmitted through the polarizer-protective film is prevented from causing variation in polarizing direction thereof, thereby suppressing adverse influences on optimization and controllability of polarized light in the transmitting axis direction of the polarizer.

### (Optional Components)

The polypropylene resin base film 3 used in the present invention is formed of a polypropylene resin mixture containing the above polypropylene and the other optional components. The content of the polypropylene in the polypropylene resin mixture is preferably 80% by mass or larger, and more preferably 85% by mass or larger.

Examples of the suitable optional components contained in the polypropylene resin mixture include ultraviolet absorbers, stabilizers, lubricants, processing assistants, plasticizers, impact-resistant assistants, matting agents, antimicrobial agents, mildew-proofing agents, etc.

When using the optical film obtained according to the production process of the present invention as a retardation film, a retardation improver is preferably added thereto as an optical component. Examples of the retardation improver include rosin-based organic substances (refer to Japanese Patent Application No. 2009-93526 filed by the present inventors), carboxylic acid amide compounds such as 1,2,3-propane tricarboxylic acid amide compound and/or 1,2,3,4-butane tetracarboxylic acid amide compound (refer to Japanese Patent Application No. 2009-121939 filed by the present inventors), and metal salts of phosphoric acid esters (refer to Japanese Patent Application No. 2010-251297 filed by the present inventors).

### (Method of Producing Polypropylene Resin Base Film)

The polypropylene resin base film 3 may be produced by mixing the polypropylene obtained by polymerization using a metallocene catalyst with various additives or additive resins according to requirements, heating and melting the resulting mixture, and forming the molten resin material into a film shape by various molding methods such as an extrusion coating/molding method, a cast molding method, a T-die extrusion molding method, an inflation molding method and an injection molding method.

The heating temperature used upon the molding is usually in the range of from 160 to 250° C., and preferably from 190 to 250° C. When the heating temperature upon the molding lies within the above specified range, it is possible to obtain the base film having a more excellent performance stability.

### <Physical Surface Treatment>

At least one surface of the polypropylene resin base film 3 is subjected to physical surface treatment to thereby provide a modified surface 2 thereon. The method for conducting the physical surface treatment is not particularly limited. Typical examples of the preferred physical surface treatment include corona discharge treatment, high-voltage corona treatment, glow discharge treatment, ultraviolet irradiation treatment, plasma treatment, electron-beam irradiation treatment, flame plasma treatment, sputtering treatment, sand blast treatment and laser treatment. In view of a good heat resistance and a good durability of the polypropylene, among these treatments, preferred are corona discharge treatment, high-voltage corona treatment, glow discharge treatment, ultraviolet irradiation treatment and plasma treatment. In the present invention, these physical surface treatments may be carried out alone or in combination of any two or more thereof.

### (Corona Discharge Treatment)

The corona discharge treatment is one of the most known surface treatments, and may be conducted by any of the conventionally known methods described, for example, in JP 48-5043B, JP 47-51905B, JP 47-28067A, JP 49-83767A, JP 51-41770A, JP 51-131576A, etc.

The discharge frequency suitably used in the corona discharge treatment is usually from about 50 Hz to about 5000 kHz, and preferably from 5 to 100 kHz. When the discharge frequency is 50 Hz or higher, stable discharge can be conducted, and the treated product is free from formation of pinholes. When the discharge frequency is 5000 kHz or lower, good impedance matching is attained, so that the corona discharge treatment can be conducted without using any special apparatus, resulting in reduced costs for apparatuses and facilities. The treatment intensity of the material to be treated is preferably from 0.001 to 5 KV·A·min/m², and more preferably from 0.01 to 1 KV·A·min/m². A gap clearance between an electrode and a dielectric roll is preferably from 0.5 to 2.5 mm, and more preferably from 1.0 to 2.0 mm.

In the present invention, at least one surface of the base film 3 is subjected to the corona discharge treatment preferably under a nitrogen atmosphere and/or a carbon dioxide gas atmosphere. The corona discharge treatment may be carried out, for example, by passing the base film 3 through a corona atmosphere generated using a known corona discharge treating device. It is necessary that the atmosphere used upon the corona discharge treatment is a nitrogen atmosphere and/or a carbon dioxide gas atmosphere. From the viewpoint of economy, the nitrogen atmosphere is preferred.

In addition, the concentration of oxygen in the nitrogen atmosphere and/or the carbon dioxide gas atmosphere is preferably 5% by volume or less, and more preferably 3% by volume or less from the viewpoint of good adhesion to a resin layer containing the hydrophilic polymer as a main component.

The corona discharge treatment (power) density calculated from the equation: voltage×current/[(electrode width)×(film traveling speed)](W·min/m²) is preferably from 1 to 200 W·min/m², more preferably from 5 to 150 W·min/m² and still more preferably from 10 to 100 W·min/m². When the treatment density is more than 1 W·min/m², the film subjected to the corona discharge treatment is free from deterioration in adhesion to the resin layer containing the hydrophilic polymer as a main component. When the treatment density is less than 200 W·min/m², the base film can be prevented from suffering from blocking between overlapped portions thereof.

### (High-Voltage Corona Treatment)

The high-voltage corona discharge treatment means the treatment using an active plasma of oxygen, etc., which is generated by intermittently applying a voltage of from several kV to several tens of kV in a pulse-like manner between two electrodes opposed to each other at a predetermined distance in atmospheric air kept at normal temperature under normal pressure. The application of such a pulse-like high voltage can suppress generation of heat, so that the base film 3 as a material to be treated is free from heating as well as hardly undergoes damage owing to spark phenomenon.

The high-voltage corona discharge treatment is usually carried out using an atmospheric plasma generator. In the high-voltage corona discharge treatment in which the pulse-like high voltage is applied, unlike the conventional corona discharge treatment, the pulse-like high voltage produced from a D.C. voltage through a pulse forming circuit is applied to generate the corona discharge. Various important factors which are required for application of the pulse-like high voltage mainly include a waveform width of the high-voltage pulse, an electric field intensity, an applied voltage, a distance between electrodes and pulse frequency, etc. The pulse width of the high-voltage pulse waveform is preferably 1 μs or more, and more preferably from 2 to 20 μs. When the pulse width of the high-voltage pulse waveform is 20 μs or less, no spark tends to occur. Whereas, when the pulse width of the high-voltage pulse waveform is 1 μs or more, an excellent surface treatment effect can be attained.

The electric field intensity is the value as calculated from the following formula.

Electric Field Intensity=Applied Voltage/Distance between Electrodes

The electric field intensity is preferably from 4 to 30 kV/cm, and more preferably from 5 to 25 kV/cm. When the electric field intensity is 30 kV/cm or less, no spark tends to occur upon the treatment. Whereas, when the electric field intensity is 4 kV/cm or more, effective corona discharge tends to readily occur so that an excellent surface treatment effect can be attained. The pulse frequency is preferably 10/s or more, and more preferably from 50/s to 100/s. In order to generate the pulse at a pulse frequency of 200/s or more, a very large scale high-voltage generator is required, resulting in high production costs. When the pulse frequency is less than 10/s, an effect of the surface treatment tends to become poor.

### (Glow Discharge Treatment)

The atmosphere used in the glow discharge treatment has such a gas composition that a total mass percentage of nitrogen and water is preferably from 80 to 90% by mass, and a mass ratio of nitrogen to water is preferably 5 or more, more preferably 10 or more, and still more preferably 15 or more. The above mass ratio of nitrogen to water may be achieved by controlling an amount of water released from the film under vacuum reduced pressure and an amount of air introduced into the vacuum system from outside, and therefore the treatment can be conducted without using a special helium or argon gas. When the mass ratio is 5 or more, the treatment may be sufficiently conducted. The measurement of the gas composition in the atmosphere used in the glow discharge treatment may be conducted by introducing the gas to be measured from a sampling tube fitted to the glow discharge treatment device into a quadrupole mass spectrometer for quantitative determination thereof.

When the base film 3 to be surface-treated is previously heated and then subjected to vacuum glow discharge treatment, the treatment can be completed for a short period of time as compared to the case where the treatment is conducted merely at an ordinary temperature. The preheating temperature is preferably from 70° C. to a glass transition temperature (Tg) of a resin constituting the base film 3, and more preferably from 80° C. to the glass transition temperature (Tg) of a resin constituting the base film 3. When the base film is preheated at a temperature not higher than the glass transition temperature (Tg), the base film can be easily handled.

As a specific method of increasing a surface temperature of the base film in vacuo, there may be mentioned the method of heating the base film using an infrared heater, the method of heating the base film by contacting with a heated roll, etc.

The thus preheated base film is then subjected to glow discharge treatment. The important treatment conditions other than the above gas composition and preheating temperature of the base film which are used in the glow discharge treatment include a vacuum degree, a discharge frequency, a discharge treatment intensity, etc. By suitably controlling these treatment conditions, it is possible to perform the glow discharge treatment in an efficient manner.

The pressure (vacuum degree) used upon the glow discharge treatment is preferably from 0.01 to 4 Torr and more preferably from 0.02 to 2 Torr. When the pressure upon the glow discharge treatment is 0.01 Torr or more, it is possible to modify the surface of the base film and reduce a surface energy thereof to a sufficient extent. On the other hand, when the pressure upon the glow discharge treatment is 4 Torr or less, a desirable glow discharge can be generated in a stable manner. The discharge frequency used in the treatment is in the range of from D.C. to several thousands of MHz similarly to those in the conventional arts, preferably from 50 Hz to 20 MHz, and more preferably from 1 kHz to 1 MHz.

In addition, the discharge treatment intensity is preferably from 0.01 to 5 W·min/m², and more preferably from 0.1 to 1 W·min/m².

### (Ultraviolet Irradiation Treatment)

The ultraviolet irradiation treatment is a treatment in which the base film 3 is irradiated with an ultraviolet ray in order to modify a surface of the base film. Examples of the ultraviolet irradiation treatment include those treatments as described in JP 43-2603B, JP 43-2604B, JP 45-3828B, etc.

The wavelength of the ultraviolet ray irradiated is preferably in the range of from 220 to 380 nm. If it is intended to suppress the excessive increase in surface temperature of the base film 3 as an object to be irradiated therewith, the ultraviolet ray having a lower wavelength within the above specified wavelength range is preferably irradiated.

As a mercury lamp used for the ultraviolet irradiation treatment, there is preferably employed a low-pressure mercury lamp and a high-pressure mercury lamp which are respectively constructed from a quartz tube. In addition, there may also be used a high-pressure mercury lamp of an ozone-less type, and a low-pressure mercury lamp. In the present invention, from the viewpoint of lowering the surface temperature of the base film 3, there is preferably used a low-pressure mercury lamp using a main wavelength of 254 nm.

A larger amount of ultraviolet ray irradiated will result in a higher effect of modifying the surface of the film. However, there tends to occur such a problem that the base film becomes brittle with the increase in amount of ultraviolet ray irradiated. In the present invention, when using the low-pressure mercury lamp using a main wavelength of 254 nm, the amount of ultraviolet ray irradiated is preferably from about 100 to about 10000 (mJ/cm²), and more preferably from 300 to 1500 (mJ/cm²).

### (Plasma Treatment)

As the plasma treatment used in the present invention, there may be mentioned a vacuum plasma treatment, a reduced-pressure plasma treatment, a normal-pressure plasma treatment, an atmospheric plasma treatment, etc. Among these plasma treatments, the normal-pressure plasma treatment is preferably used because of relatively low facility costs thereof, etc.

In the plasma treatment, there may be suitably used conventional plasma generators including internal and external capacitively-coupled plasma, inductively-coupled plasma and resistively-coupled plasma, as well as thermal plasma using wave guide techniques, radio frequency plasma, DC plasma, audio frequency plasma and ultrahigh frequency plasma. The electric excitation of these plasma generators is performed by supplying a power thereto by means of DC or low-frequency AC glow discharge generated from an internal electrode which is coupled through an inductive or capacitive means to a high-frequency power source operated in the range of from audio frequency to radio frequency and further up to microwave frequency.

The electrodes used in the plasma discharge treatment are formed by coating a surface of metal, glass, quartz, ceramic or the like, with a dielectric material whose surface is hardly decomposed by an energy of plasma excited by the glow discharge.

In order to generate plasma in the plasma treatment for modifying the surface of the base film, it is required to control a power source, a radio frequency, an exposure duration, a temperature and a gas pressure over a wide range. The power source preferably has a DC or AC output power density level ranging from 5 to 30 W (preferably from 15 to 25 W). The radio frequency is preferably 13.56 MHz or less; the exposure duration is preferably from 5 s to 10 min; the temperature is preferably from 10 to 40° C.; and the gas pressure is preferably from 0.04 to 0.40 Torr. The gas flow rate is varied from a stagnated state to a capacitive substitution at a certain level per second. The pump down pressure for controlling an oxygen concentration is from 0.01 to 0.001 Torr. The pump down pressure may be reached after the elapse of 10 to 30 min on the basis of a capacity of the pump used.

Examples of the gas preferably used for producing the plasma gas include inert gases such as helium, argon, krypton, xenon, neon, radon and nitrogen, oxygen, air, carbon monoxide, carbon dioxide, carbon tetrachloride, chloroform, hydrogen, ammonia, carbon tetrafluoride, trichlorofluoroethane, trifluoromethane, acetone and silane. In addition, there may also be used a known fluoride gas or a mixed gas of the above gases. Examples of a preferred combination of the gases in the mixed gas include argon/oxygen, argon/ammonia, argon/helium/oxygen, argon/carbon dioxide, argon/nitrogen/carbon dioxide, argon/helium/nitrogen, argon/helium/nitrogen/carbon dioxide, argon/helium, argon/helium/acetone, helium/acetone, helium/air, and argon/helium/silane.

The treatment density for the plasma treatment is preferably in the range of from 100 to 10000 W·min/m², and more preferably from 300 to 7000 W·min/m². When the treatment density for the plasma treatment lies within the above specified range, it is possible to attain an adequate effect of modifying the surface of the base film.

### (Electron-Beam Irradiation Treatment)

As the physical surface treatment used in the present invention, there may also be mentioned an electron-beam irradiation treatment.

In the present invention, an accelerating voltage of electron beams in the treatment may be appropriately selected depending upon a resin used or a thickness of the base film 3, and is usually from about 100 to about 1000 keV, and preferably from 70 to 300 kV. The penetrability of electron beams irradiated becomes higher as the accelerating voltage increases. Therefore, when using a high accelerating voltage, there tends to occur deterioration of the base film 3. In such a case, the accelerating voltage of electron beams irradiated may be determined such that a penetration depth of electron beams irradiated and a thickness of the resin layer are substantially identical to each other. As a result, the base film can be prevented from being excessively irradiated with electron beams, whereby deterioration of the base film 3 owing to excessive irradiation with electron beams can be minimized.

The irradiation dose of electron beams is preferably an amount capable of saturating a crosslinking density of the resin layer, and may be selected from the range of usually from about 5 to about 300 kGy (from 0.5 to 30 Mrad), and preferably from 10 to 50 kGy (from 1 to 5 Mrad). When the irradiation dose of electron beams is 5 kGy or more, a sufficient surface treatment effect can be attained. When the irradiation dose of electron beams is 200 kGy or less, the resin layer can be prevented from exhibiting an excessively high crosslinking density, so that the cured base film 3 is susceptible to no damage.

In addition, the surface treatment is suitably carried out in an atmosphere having an oxygen concentration of 500 ppm or less, usually about 200 ppm.

The electron beam source used in the treatment is not particularly limited. For example, electron beams are irradiated by an electron curtain method, a beam scanning method, etc, using various electron beam accelerators such as a Cockroft-Walton type accelerator, a van de Graaff type accelerator, a resonant transducer type accelerator and an insulated core transducer type accelerator, and further a linear type accelerator, a Dynamitron type accelerator and a high frequency type accelerator. Among these accelerators, preferred is an apparatus “Electrocurtain (tradename)” which is capable of irradiating electron beams in a curtain-like and uniform manner from a linear filament.

Meanwhile, the irradiation dose of the electron beams may be calculated from the following formula, i.e., by multiplying an apparatus constant determined according to the respective apparatuses by a current value, and dividing the obtained product by a treating speed.

Irradiation Dose (kGy)=(Apparatus Constant)×(Total Electron Current (mA))/(Treating Speed (m/min))

### (Flame Plasma Treatment)

The flame plasma treatment may be conducted by known methods. For example, a plasma ionized in a flame generated when burning a natural gas, LPG, a propane gas, a butane gas, etc., using a burner, etc., is blown on a surface of the base film 3.

In the flame plasma treatment, it is important to apply a heat in the form of a flame to such an extent as to cause no damage to the base film 3. The flame treatment conditions may be adequately controlled to produce a desired surface energy.

The flame plasma treatment intensity is preferably from 1 to 15 kcal/m², more preferably from 2 to 10 kcal/m², and still more preferably from 3 to 8 kcal/m². The flame plasma treatment intensity as used herein means the value as calculated from the formula: (Burner Output)/[(Burner Width)×(Film Traveling Speed)] (kcal/m²). When the above treatment intensity is 1 kcal/m² or more, the base film has a good adhesion property to the hydrophilic resin layer 1. When the treatment intensity is 15 kcal/m² or less, the polypropylene resin base film can be desirably prevented from suffering from occurrence of wrinkles owing to heat shrinkage.

The distance between the burner device and the base film 3 to be treated may vary depending upon the size of flame generated, and may be usually appropriately selected from the range of from 10 to 100 mm. The distance between a tip end of an inner flame in the flame and the surface of the base film 3 to be treated is preferably from 1 to 5 mm and more preferably from 1 to 3 mm in view of stable level of the treatment.

In addition, the temperature control of the base film 3 upon the flame plasma treatment may be generally carried out by the method in which a flame plasma is blown on a surface of the film which is kept traveled while contacting an opposite surface thereof with a cooling roll. The temperature of the cooling roll may be appropriately selected from the range of from room temperature to 60° C., and is preferably from 30 to 45° C.

### (Sputtering Treatment)

In the present invention, a sputtering treatment may also be used as the physical surface treatment. Examples of the sputtering treatment include a DC bipolar sputtering method, a bias sputtering method, an asymmetric AC sputtering method, a getter sputtering method and a high-frequency sputtering method. As the film to be formed on the base film 3 by the sputtering treatment, metal films such as aluminum, copper, zinc, titanium, nickel and chromium films and non-metal films such as alumina and silica films may be suitably used from the viewpoint of inexpensiveness.

### (Sand Blast Treatment)

The sand blast treatment is a surface treatment in which an abrasive material is blown onto the surface of the base film 3 by compressed air. For example, there may be used a sand blaster equipped with a sandblast nozzle. The amount of the abrasive material blown may be appropriately adjusted, but must be controlled such that after completion of the treatment, neither abrasive material nor abraded chips remain on the surface of the polyimide film, and the polyimide film is free from deterioration in strength thereof. More specifically, as the abrasive material, there may be typically used quartz sand which usually has a particle size of from about 0.05 to about 10 mm and preferably from 0.1 to 1 mm.

The blast distance is preferably from 100 to 300 mm. The blast angle is preferably from 45 to 90° and more preferably from 45 to 60°. The blast amount is preferably from 1 to 10 kg/min. The abrasion depth of the sand blast treatment is preferably controlled to lie within the range of from 0.01 to 0.1 μm so as not to cause deterioration in strength of the film to be treated.

### (Laser Treatment)

The laser treatment is not particularly limited, and preferably an ultraviolet laser treatment.

The ultraviolet laser used in the ultraviolet laser treatment is a laser having a wavelength of 150 to 380 nm. Examples of the preferred laser include lasers of XeF, XeCl, KrF and ArF, as well as a copper vapor laser and harmonic lasers such as YAG laser. Among these lasers, preferred is KrF laser having a wavelength of 248 nm.

The laser irradiation method is not particularly limited. The irradiation of the laser may be carried out in air, in an inert gas, under pressure or in vacuo. The temperature upon irradiation of the laser is preferably in the range of from an ordinary temperature to 100° C.

The important laser irradiation conditions include an irradiation fluence and a number of irradiation shots. The irradiation fluence is usually in the range of preferably from 1 to 500 mJ/cm²/pulse and more preferably from 30 to 80 mJ/cm²/pulse. The irradiation fluence is preferably lower as long as it is not less than a threshold value thereof, from the viewpoint of good properties of the resulting film. However, in order to modify a certain depth of a surface layer portion of the film, the laser is preferably irradiated such that the irradiation fluence lies within the above specified range.

(Properties of Surface of Base Film after Physical Surface Treatment)

In the present invention, a wetting index of the surface of the base film 3 after completion of the physical surface treatment is preferably from 35 to 60 mN/m, more preferably from 38 to 58 mN/m and still more preferably from 40 to 55 mN/m. When the wetting index of the surface of the base film is 35 mN/m or more, the base film has an excellent adhesion property to the hydrophilic resin layer 1, whereas when the wetting index of the surface of the base film is 65 mN/m or less, the base film can be desirably prevented from suffering from occurrence of wrinkles owing to heat shrinkage as well as blocking between overlapped portions of the base film.

The treated surface of the base film 3 preferably has a surface roughness (Ra value) of from 0.5 to 100 nm, more preferably from 1 to 80 nm and still more preferably from 3 to 50 nm from the viewpoint of a good adhesion property.

### <Hydrophilic Resin>

The hydrophilic resin layer 1 is provided for enhancing adhesion of the optical film obtained according to the production process of the present invention to polarizers or other protective films for polarizers.

The hydrophilic resins constituting the hydrophilic resin layer 1 are not particularly limited as long as they are in the form of a resin having a chemical affinity with PVA-based resins to be bonded to the polarizers. Examples of the preferred hydrophilic resins include acrylic resins, urethane resins, polyester resins and epoxy resins. These hydrophilic resins may be used alone or in combination of any two or more thereof. These hydrophilic resins have a weight-average molecular weight of usually from about 100 to about 100,000 and preferably from 200 to 40,000.

### (Acrylic Resin)

The acrylic resin constituting the hydrophilic resin layer 1 may be synthesized by polymerizing a reactive monomer having a skeleton derived from (meth)acrylic acid. Examples of the reactive monomer include carboxyl group-containing monomers such as (meth)acrylic acid, carboxyethyl(meth)acrylate and carboxyphenyl acrylate; hydroxyl group-containing monomers such as 2-hydroxyethyl (meth)acrylate, 2-hydroxypropyl(meth)acrylate, 3-hydroxypropyl (meth)acrylate and 3-hydroxybutyl(meth)acrylate; amide group-containing monomers such as (meth)acrylamide, N-methyl(meth)acrylamide, N-ethyl(meth)acrylamide, N,N-dimethyl(meth)acrylamide and N-methylol(meth)acrylamide; glycidyl group-containing monomers such as glycidyl(meth)acrylate; amino group-containing monomers such as 7-amino-3,7-dimethyloctyl(meth)acrylate and 2-dimethylaminoethyl(meth)acrylate; and other monomers such as p-chlorostyrene, chloromethyl styrene, divinyl benzene, 4-vinyl pyridine, vinyl oxazoline and maleic anhydride.

Examples of the comonomer component other than the above reactive monomers in the acrylic resin include (meth)acrylic acid ester-based compounds, propylene-based compounds, vinyl-chloride-based compounds, cellulose-based compounds, ethylene-based compounds, ethylene-imine-based compounds, vinyl alcohol-based compounds, peptide-based compounds, vinyl pyridine-based compounds, diene-based compounds, fluorine-based compounds and acrylonitrile-based compounds. From the viewpoints of a good flexibility and a good coatability, the acrylic resin preferably contains the (meth)acrylic acid ester-based compound as the comonomer component. These components constituting the acrylic resin may be respectively used alone or in combination of any two or more thereof.

### (Urethane Resin)

The urethane resin constituting the hydrophilic resin layer 1 may be synthesized from a polyhydroxyl compound, a diisocyanate and a low-molecular weight chain extender having at least two hydrogen atoms which are capable of reacting with the diisocyanate by known methods. For example, the urethane resin may be produced by the method in which a polyurethane having a relatively large molecular weight is synthesized in a solvent, and then water is gradually added thereto to subject the polyurethane to phase reversal of emulsion and remove the solvent under reduced pressure, the method in which a urethane prepolymer prepared by introducing a hydrophilic group such as a polyethylene glycol and a carboxyl group into a polymer is dissolved or dispersed in water, and then a chain extender is added to the resulting solution or dispersion to react therewith, or the like.

Examples of the polyhydroxyl compound used for production of the urethane resin include carboxylic acids such as phthalic acid, adipic acid, dimerized linolenic acid and maleic acid; glycols such as ethylene glycol, propylene glycol, butylene glycol and diethylene glycol; polyester polyols produced from trimethylol propane, hexanetriol, glycerol, trimethylol ethane, pentaerythritol, etc., by dehydration condensation reaction thereof; polyether polyols such as polyoxypropylene polyols and polyoxypropylene/polyoxyethylene polyols which are produced using, as an initiator, polyoxypropylene glycol, polyoxybutylene glycol, polytetramethylene glycol, polyoxypropylene triol, polyoxyethylene/polyoxypropylene triol, sorbitol, pentaerythritol, sucrose, starch and an inorganic acid such as phosphoric acid; and acrylic polyols, castor oil derivatives, tall oil derivatives and other hydroxyl group-containing compounds. These polyhydroxyl compounds may be used alone or in combination of any two or more thereof.

Examples of the diisocyanate used for production of the urethane resin include 2,4-tolylene diisocyanate, 2,6-tolylene diisocyanate, m-phenylene diisocyanate, p-phenylene diisocyanate, 4,4′-diphenylmethane diisocyanate, tetramethylene diisocyanate, hexamethylene diisocyanate, xylylene diisocyanate, lysine diisocyanate, isophorone diisocyanate, trimethylhexamethylene diisocyanate, 1,4-cyclohexylene diisocyanate, 4,4′-dicyclohexylmethane diisocyanate, 3,3′-dimethyl-4,4′-biphenylene diisocyanate, 3,3′-dimethoxy-4,4′-biphenylene diisocyanate, 3,3′-dichloro-4,4′-biphenylene diisocyanate, 1,5-naphthalene diisocyanate and 1,5-tetrahydronaphthalene diisocyanate. These diisocyanates may be used alone or in combination of any two or more thereof.

Examples of the chain extender used for production of the urethane resin include polyols such as ethylene glycol, 1,4-butanediol, trimethylol propane, triisopropanol amine, N,N-bis(2-hydroxypropyl)aniline, hydroquinone-bis(β-hydroxyethyl)ether and resorcinol-bis(β-hydroxyethyl)ether; polyamines such as ethylenediamine, propylenediamine, hexamethylenediamine, phenylenediamine, tolylenediamine, diphenyldiamine, diaminodiphenylmethane, diaminodiphenylmethane, diaminodicyclohexylmethane, piperazine, isophoronediamine, diethylenetriamine and dipropylenetriamine; hydrazines; and water. These chain extenders may be used alone or in combination of any two or more thereof.

The synthesis reaction for production of the urethane resin may be carried out in the presence of a catalyst such as an organic tin compound, an organic bismuth compound and an amine, especially preferably in the presence of the organic tine compound. Specific examples of the organic tin compound include stannous carboxylates such as stannous acetate, stannous octanoate, stannous laurate and stannous oleate; dialkyl tin salts of carboxylic acids such as dibutyl tin acetate, dibutyl tin dilaurate, dibutyl tin maleate, dibutyl tin di-2-ethylhexoate, dilauryl tin diacetate and dioctyl tin diacetate; trialkyl tin hydroxides such as trimethyl tin hydroxide, tributyl tin hydroxide and trioctyl tin hydroxide; dialkyl tin oxides such as dibutyl tin oxide, dioctyl tin oxide and dilauryl tin oxide; and dialkyl tin chlorides such as dibutyl tin dichloride and dioctyl tin dichloride. These organic tin compounds may be used alone or in combination of any two or more thereof.

### (Epoxy Resin)

The epoxy resin constituting the hydrophilic resin layer 1 may be synthesized by polymerizing an epoxy group-containing monomer. Examples of the epoxy group-containing monomer include glycidyl (meth)acrylate and allyl glycidyl ether. As a comonomer capable of copolymerizing with these monomers, there may be used vinyl esters, unsaturated carboxylic acid esters, unsaturated carboxylic acid amides, unsaturated nitriles, allyl compounds, unsaturated hydrocarbons or vinyl silane compounds. Specific examples of the comonomer include vinyl propionate, vinyl chloride, vinyl bromide, methyl(meth)acrylate, butyl(meth)acrylate, 2-ethylhexyl acrylate, butyl maleate, octyl maleate, butyl fumarate, octyl fumarate, hydroxyethyl(meth)acrylate, hydroxypropyl(meth)acrylate, ethylene glycol di(meth)acrylic acid ester, polyethylene glycol di(meth)acrylic acid ester, (meth)acrylamide, methylol (meth)acrylamide, butoxymethylol(meth)acrylamide, unsaturated nitriles such as acrylonitrile, allyl acetate, allyl(meth)acrylate, diallyl itaconate, ethylene, propylene, hexene, octene, styrene, vinyl toluene, butadiene, dimethylvinyl methoxysilane, dimethylethyl ethoxysilane, methylvinyl dimethoxysilane, methylvinyl diethoxysilane, γ-methacryloxypropyl trimethoxysilane and γ-methacryloxypropylmethyl dimethoxysilane. These components constituting the epoxy resin may be used alone or in combination of any two or more thereof.

### (Polyester Resin)

The polyester resin constituting the hydrophilic resin layer 1 may be produced by subjecting a dicarboxylic acid and a diol to esterification (transesterification) and then to polycondensation according to known methods. Examples of the dicarboxylic acid include aromatic dicarboxylic acids such as terephthalic acid, isophthalic acid, phthalic acid and naphthalenedicarboxylic acid, and esters thereof; and aliphatic dicarboxylic acids such as adipic acid, succinic acid, sebacic acid and dodecanedioic acid, hydroxycarboxylic acids such as hydroxybenzoic acid, and esters thereof. Examples of the diol include ethylene glycol, propylene glycol, 1,4-butanediol, 1,6-hexanediol, neopentyl glycol, cyclohexane dimethanol and bisphenols.

The polyester resin is preferably imparted with a hydrophilic property by copolymerizing a hydrophilic group-containing component in addition to the above dicarboxylic acid and diol. Examples of the hydrophilic group-containing component include dicarboxylic acid components such as 5-sodium sulfoisophthalic acid, and diol components such as diethylene glycol, triethylene glycol and polyethylene glycol. The hydrophilic group-containing component may be used, for example, in an amount of from 2 to 80 mol % on the basis of the above dicarboxylic acid or diol. These components constituting the polyester-based resin may be used alone or in combination of any two or more thereof.

### (Hydrophilic Modification for Hydrophilic Resin)

The hydrophilic resin used in the present invention preferably has a side chain modified with a hydrophilic group. As the method of hydrophilic modification for the hydrophilic resin, there may be used the method of previously copolymerizing a hydrophilic functional group-containing monomer to the resin, or the method of (co)polymerizing a monomer constituting a main chain of the resin and then graft-polymerizing a hydrophilic group-containing monomer (hydrophilic monomer) to the resulting (co)polymer to form a side chain thereof. In the method of (co)polymerizing the monomer constituting a main chain of the resin and then graft-polymerizing the hydrophilic monomer to the resulting (co)polymer to form a hydrophilic side chain thereof, the hydrophilic monomer to be graft-polymerized is preferably a hydrophilic radical-polymerizable vinyl monomer. In this case, the hydrophilic radical-polymerizable vinyl monomer may be used in an amount of from 10 to 500 parts by mass on the basis of 100 parts by mass of a total amount of the main chain components.

Examples of the hydrophilic radical-polymerizable vinyl monomer include those monomers having a hydrophilic group represented by the formula: —CH₂—CH(R¹)—OH (wherein R¹ is a hydrogen atom or a methyl group); —COOX (wherein X is a hydrogen atom, an alkali metal or a secondary or tertiary amino group); —O—(CH₂—CH(R²)—O)ₙ— (wherein R² is a hydrogen atom or a methyl group; and n is a positive integer); —Y—N(R³)(R⁴) (wherein Y is an oxo group or a methylene group; R³ and R⁴ are each independently a hydrogen atom or an alkyl group having 1 to 8 carbon atoms which may contain a hydroxyl group, a sulfonyl group, an acyl group, an amino group, an alkali metal salt or a quaternary ammonium salt); —N⁺—(R⁵)(R⁶)(R⁷) (wherein R⁵ to R⁷ are each independently a methyl group or an ethyl group); —CH₂—CH(O)CH₂ (wherein O cooperates with carbon atoms on both sides thereof to form an epoxy ring); or the like.

Specific examples of the hydrophilic radical-polymerizable vinyl monomer include hydroxy(meth)acrylic acid esters such as hydroxyethyl(meth)acrylate and hydroxypropyl(meth)acrylate; glycol esters such as ethylene glycol(meth)acrylate and polyethylene glycol(meth)acrylate; acrylamide compounds such as (meth)acrylamide, methylol(meth)acrylamide and methoxymethylol(meth)acrylamide; glycidyl(meth)acrylate compounds such as glycidyl(meth)acrylate; nitrogen-containing vinyl-based compounds such as vinyl pyridine, vinyl imidazole and vinyl pyrrolidone; unsaturated acids such as (meth)acrylic acid, maleic anhydride, itaconic acid and crotonic acid, and salts thereof; and cationic monomers such as (meth)acrylic acid aminoalkyl esters and quaternary ammonium salts thereof.

In the hydrophilic modification for the hydrophilic resin, in addition to these radical-polymerizable vinyl monomers, other vinyl monomers may be copolymerized therewith. Examples of the other copolymerizable vinyl monomers include vinyl esters such as vinyl acetate and vinyl propionate; vinyl halides such as vinyl chloride and vinyl bromide; unsaturated carboxylic acid esters such as methyl(meth)acrylate, ethyl(meth)acrylate and butyl(meth)acrylate; vinyl silanes such as dimethylvinyl methoxysilane and γ-methacryloxypropyl trimethoxysilane; and olefins or diolefin compounds such as ethylene, propylene, styrene and butadiene.

Thus, the hydrophilic resin constituting the hydrophilic resin layer 1 is formed of an acrylic resin, a urethane resin, an epoxy resin or a polyester resin, and these resins are modified to exhibit a hydrophilic property. Therefore, the hydrophilic resin constituting the hydrophilic resin layer 1 exhibits a high chemical affinity to PVA-based resins constituting the polarizers so that adhesion between the hydrophilic resin layer 1 and the polarizers can be enhanced.

In addition, the hydrophilic resin exhibits a hydrophilic property by itself to a certain extent. Therefore, the hydrophilic resin layer 1 formed of such a resin can be directly subjected to a bonding step for bonding the film to the polarizers without via saponification treatment.

### [Process for Producing Optical Film]

The process for producing an optical film according to the present invention includes the following steps (1) and (2):

Step (1): subjecting at least one surface of a polypropylene resin base film to physical surface treatment; and

Step (2): applying a hydrophilic resin composition onto the physically treated surface of the polypropylene resin base film. When conducting the process for producing an optical film according to the present invention, it is possible to obtain the optical film as described above.

### <<Step (1)>>

In the step (1), at least one surface of the polypropylene resin base film is subjected to physical surface treatment. The polypropylene resin base film 3 may be obtained by the above-mentioned method. Next, at least one surface of the thus obtained base film 3 is subjected to the physical surface treatment. The details of the physical surface treatment are as described previously.

### <<Step (2)>>

In the step (2), the base film 3 having a modified surface 2 which is obtained by the physical surface treatment of the step (1) is subjected to a coating step in which the hydrophilic resin composition in the form of an aqueous emulsion or an aqueous solution is applied onto the modified surface 2. After completion of the step (2), the thus applied hydrophilic resin composition is dried to form the hydrophilic resin layer 1, thereby obtaining the optical film as aimed.

The hydrophilic resin composition containing the hydrophilic resin is usually a one-component liquid, and is a composition in the form of an aqueous emulsion or an aqueous solution.

The hydrophilic resin composition has a solid content of usually from 10 to 50% by mass. In the hydrophilic resin composition, water is used as a main solvent. However, a water-miscible organic solvent may also be used therein in a small amount. Examples of the organic solvent include lower alcohols, polyhydric alcohols, and alkyl ethers or alkyl esters thereof. The hydrophilic resin composition may be applied onto the modified surface 2 of the base film 3 by known methods such as a dip coating method, an air-knife coating method, a curtain coating method, a roller coating method, a wire bar coating method, a gravure coating method and an extrusion coating method (die coating method).

The hydrophilic resin composition for forming the hydrophilic resin layer 1 may contain a crosslinking agent, if required, unless the drying temperature of the composition becomes excessively high. Examples of the preferred crosslinking agent include aldehydes, N-methylol compounds, dioxane derivatives, active vinyl compounds, active halogen compounds, isooxazole, dialdehyde starches, isocyanate-based compounds and silane coupling agents. These crosslinking agents may be used alone or in combination of any two or more thereof.

The amount of the crosslinking agent added is preferably from 0.1 to 20% by mass, and more preferably from 0.5 to 15% by mass on the basis of a total amount of the hydrophilic resins. The hydrophilic resin composition for forming the hydrophilic resin layer 1 may also contain the other resin components such as amino group-containing resins, a surfactant, a slip agent, a dye, an ultraviolet absorber, a matte agent, an antiseptic agent, a thickener, a film-forming assistant, an antistatic agent, an antioxidant, etc., if required.

Next, the thus applied hydrophilic resin composition is dried to form the hydrophilic resin layer 1, thereby obtaining the optical film as desired. It is required that the thus applied hydrophilic resin composition is dried at a temperature not higher than a melting point of the polypropylene resin base film 3 because the heat resistance of the base film 3 is not so high.

The thickness of the thus formed hydrophilic resin layer 1 is preferably from 0.01 to 10 μm and more preferably from 0.05 to 2 μm. When the thickness of the hydrophilic resin layer 1 is 0.01 μm or more, adhesion between the hydrophilic resin layer 1 and the PVA-based resin constituting the polarizers can be ensured. When the thickness of the hydrophilic resin layer 1 is 10 μm or less, the thickness of the polarizer-protective film can be sufficiently reduced in view of the production costs.

In the production process of the present invention, it is not required to conduct a stretching treatment. Therefore, no variation in in-plane retardation nor internal heat shrinkage stress owing to the stretching is caused. As a result, it is possible to readily produce a high-quality retardation film in a stable manner, and reduce a man hour and therefore costs. Thus, from the viewpoint of reducing costs for production of the retardation film, it is preferred to conduct no stretching treatment.

The thus obtained optical film including the base film 3 formed of a transparent polypropylene resin can exhibit a high transparency required for the polarizer-protective film. In addition, the polarizer-protective film obtained by laminating the hydrophilic resin layer on the surface of the base film has an excellent affinity to the PVA-based adhesive which is also formed of a hydrophilic resin, so that excellent adhesion between the protective film and the polarizers can be ensured. Further, the hydrophilic resin itself exhibits a hydrophilic property and therefore can be directly subjected to bonding to the polarizers without conducting such a saponification treatment as required for TAC films used as the conventional polarizer-protective film.

The optical film obtained according to the production process of the present invention can be suitably used as a polarizer-protective film or a retardation film. For example, when using the optical film obtained according to the production process of the present invention as a protective film for the polarizer formed of polyvinyl alcohol, it is possible to produce a polarizing plate.

Furthermore, when laminating the polarizing plate on at least one surface of a liquid crystal cell, it is possible to produce a liquid crystal display device. In the liquid crystal display device, since the adhesion property and adhesion durability between the polarizer and the polarizer-protective film are high, and the resulting polarizing plate is excellent in strength and handling property, the liquid crystal display device can stably exhibit various excellent properties thereof over a long period of time, resulting in enhanced reliability thereof.

### [Polarizing Plate]

The optical film obtained according to the production process of the present invention may be laminated on at least one surface of the polarizer to form a polarizing plate. The polarizing plate may be formed by the method in which the optical film is previously prepared and then laminated on the polarizer through an adhesive layer 10, or by the method in which the optical film is directly molded on the polarizer.

In FIG. 2, there is shown an example of construction of the polarizing plate produced using the optical film obtained according to the production process of the present invention. The polarizing plate shown in FIG. 2 includes the polarizer 6, the optical film 4 obtained according to the production process of the present invention which is provided as a polarizer-protective film on one surface of the polarizer 6 and includes the base film 3, the modified surface 2 and the hydrophilic resin layer 1, and a TAO film 5 provided on the other surface of the polarizer 6 as a protective film for the inside surface of the polarizer. The optical film obtained according to the production process of the present invention is disposed in the polarizing plate such that the hydrophilic resin layer 1 of the optical film is bonded to the one surface of the polarizer 6 through the adhesive layer 10. Meanwhile, in FIG. 2, the TAC film 5 may used for the sake of convenience. However, any suitable conventional films formed of the other materials may also be used instead of the TAC film.

### <<Polarizer>>

The polarizer used in the polarizing plate may be of any type as long as it has a function capable of allowing only light having a specific vibration direction to penetrate therethrough. As the polarizer, there is preferably used a PVA-based polarizer which is usually obtained by stretching a PVA-based film, etc., and then dyeing the thus stretched film with iodine or a dichromatic pigment.

The PVA-based polarizer may include, for example, those polarizers produced by allowing a hydrophilic polymer film such as a PVA-based film, a partially formalized polyvinyl alcohol-based film and a partially saponified ethylene/vinyl acetate copolymer-based film to adsorb a dichromatic substance such as iodine and a dichromatic dye, and subjecting the thus dyed film to monoaxial stretching. Among these polarizers, there can be suitably used the polarizers produced from a PVA-based film and a dichromatic substance such as iodine. The thickness of these polarizers is not particularly limited, and is generally from about 1 to about 100 μm.

The PVA-based resin suitably used as the resin constituting the polarizer may be obtained by saponifying a polyvinyl acetate-based resin. Examples of the polyvinyl acetate-based resin include polyvinyl acetate as a homopolymer of vinyl acetate, and copolymers of vinyl acetate with other monomers copolymerizable therewith. Examples of the other monomers copolymerizable with vinyl acetate include unsaturated carboxylic acids, olefins, vinyl ethers and unsaturated sulfonic acids.

The saponification degree of the PVA-based resin is usually in the range of from 85 to 100 mol % and preferably from 98 to 100 mol %. The PVA-based resin may be further modified. For example, polyvinyl formal or polyvinyl acetal which is modified with aldehydes may be used. The polymerization degree of the PVA-based resin is usually in the range of from 1,000 to 10,000, and preferably from 1,500 to 10,000.

### <<Method for Producing Polarizing Plate>>

The polarizing plate may be produced, for example, through a step (I) of subjecting the above PVA-based film to monoaxial stretching; a step (II) of dyeing the PVA-based film with a dichromatic pigment to adsorb the dichromatic pigment onto the film; a step (III) of treating the PVA-based film onto which the dichromatic pigment is adsorbed, with a boric acid aqueous solution; a step (IV) of washing the PVA-based film with water after treated with the boric acid aqueous solution; and a step (V) of attaching the optical film as a polarizer-protective film to the PVA-based film subjected to the above respective steps which has been monoaxially stretched and on which the dichromatic pigment has been adsorbed and oriented.

### <Step (I)>

The monoaxial stretching of the film may be carried out before, during or after being dyed with the dichromatic pigment. The monoaxial stretching of the film after being dyed with the dichromatic pigment may be carried out before or during the boric acid treatment or at plural stages including both before and during the boric acid treatment. The monoaxial stretching may be performed using a pair of rolls which are different in peripheral speed from each other or heated rolls. In addition, the monoaxial stretching may be carried out by a dry stretching method in which the stretching is conducted in atmospheric air, or by a wet stretching method in which the stretching is conducted in a swelled state using a solvent. The stretch ratio is usually from about 4 to about 8 times.

### <Step (II)>

In order to dye the PVA-based film with the dichromatic pigment, the PVA-based film may be, for example, dipped in an aqueous solution containing the dichromatic pigment. Specific examples of the dichromatic pigment used herein include iodine and dichromatic dyes.

When using iodine as the dichromatic pigment, there may be adopted such a dying method in which the PVA-based film is dipped in an aqueous solution containing iodine and potassium iodide. The content of iodine in the aqueous solution is usually from about 0.01 to about 0.5 part by mass per 100 parts by mass of water. The content of potassium iodide in the aqueous solution is usually from about 0.5 to about 10 parts by mass per 100 parts by mass of water. The temperature of the aqueous solution is usually from about 20 to about 40° C. Also, the dipping time of the film in the aqueous solution is usually from about 30 s to about 300 s.

On the other hand, when using the dichromatic dye as the dichromatic pigment, there may be adopted such a dying method in which the PVA-based film is dipped in an aqueous solution containing a water-soluble dichromatic dye. The content of the water-soluble dichromatic dye in the aqueous solution is usually from about 0.001 to about 0.01 part by mass per 100 parts by mass of water. The aqueous solution may also contain an inorganic salt such as sodium sulfate. The temperature of the aqueous solution is usually from about 20 to about 80° C. Also, the dipping time of the film in the aqueous solution is usually from about 30 s to about 300 s.

### <Step (III)>

The boric acid treatment after being dyed with the dichromatic pigment may be conducted by dipping the thus dyed PVA-based film in a boric acid aqueous solution. The content of boric acid in the boric acid aqueous solution is usually from about 2 to about 15 parts by mass and preferably from about 5 to about 12 parts by mass per 100 parts by mass of water.

When using iodine as the dichromatic pigment, the boric acid aqueous solution preferably contains potassium iodide. The content of potassium iodide in the boric acid aqueous solution is usually from about 2 to about 20 parts by mass and preferably from 5 to 15 parts by mass per 100 parts by mass of water. The dipping time of the film in the boric acid aqueous solution is usually from about 100 s to about 1,200 s, preferably from about 150 s to about 600 s and more preferably from about 200 s to about 400 s. The temperature of the boric acid aqueous solution is usually 50° C. or higher and preferably from 50 to 85° C.

### <Step (IV)>

The PVA-based film after subjected to the boric acid treatment is usually washed with water. The water-washing treatment may be conducted, for example, by dipping the boric acid-treated PVA-based film in water. After completion of the water-washing treatment, the PVA-based film is dried to obtain a polarizer. The temperature of water used in the water-washing treatment is usually from about 5 to about 40° C. The dipping time of the film in water is usually from about 2 s to about 120 s. The drying treatment subsequent to the dipping may be usually conducted using a hot air dryer or a far infrared heater. The drying temperature is usually from 40 to 100° C. The drying treatment time is usually from about 120 s to about 600 s.

Thus, it is possible to obtain a polarizer constituted from the PVA-based film on which iodine or the dichromatic dye is adsorbed and oriented.

### <Step (V)>

The polarizer 6 and the optical film 4 are laminated on each other through the adhesive layer 10. The adhesive forming the adhesive layer 10 is a so-called “aqueous glue”, and may include, for example, PVA-based adhesives vinyl-based latexes such as butyl acrylate. These adhesives may be usually used in the form of an aqueous solution thereof. The solid concentration of a resin solution containing the adhesive is preferably from 0.1 to 15% by mass in view of good coatability and standing stability. The viscosity of the resin solution containing the adhesive is preferably, for example, in the range of from 1 to 50 mPa·s. The PVA-based adhesive is usually used for forming the adhesive resin layer.

The PVA-based adhesive contains a PVA-based resin and a crosslinking agent. Examples of the PVA-based resin include PVA obtained by saponifying polyvinyl acetate and a derivative thereof, a saponified product of a copolymer of vinyl acetate with a monomer copolymerizable with vinyl acetate such as an unsaturated carboxylic acid and an ester thereof, and an α-olefin, and modified PVAs such as acetalized (acetal-modified), urethanated (urethane-modified), etherified (ether-modified), grafted and phosphoric acid-esterified (phosphoric acid ester-modified) products of PVA, and polyvinyl butyral. These PVA-based resins may be used alone or in combination of any two or more thereof.

The polymerization degree and the like of the PVA-based resin are not particularly limited. From the viewpoint of a good adhesion property, the average polymerization degree of the PVA-based resin is from about 100 to about 3000 and preferably from 500 to 3000; and the average saponification degree of the PVA-based resin is from about 85 to about 100 mol % and preferably from about 90 to about 100 mol %.

The polarizer 6 or the adhesive layer 10 may be imparted with an ultraviolet absorptivity, for example, by the method of treating them with an ultraviolet absorber such as salicylic acid ester-based compounds, benzophenol-based. compounds, benzotriazole-based compounds, cyanoacrylate-based compounds and nickel complex salt-based compounds.

Also, the adhesive layer 10 may be formed on one or both of the optical film and the polarizer by applying an adhesive thereto. The thickness of the adhesive layer 10 is preferably from 0.01 to 10 μM and more preferably from 0.03 to 5 μm.

Next, after the adhesive layer 10 is formed on the surface subjected to the above easy-bonding treatment, the polarizer 6 and the optical film 4 are laminated on each other through the adhesive layer 10.

The lamination of the polarizer 6 and the optical film 4 may be conducted using a roll laminator, etc. Meanwhile, the heat-drying temperature and the drying time may be appropriately determined according to the kind of adhesive used.

Next, in the case of the polarizing plate 7 as shown in FIG. 2, a TAC film 5 (a protective film for an inside surface of the polarizer) is also laminated on the surface of the polarizer 6 on which no optical film 4 is laminated, by a similar method, to thereby obtain the polarizing plate. The TAC film 5 is preferably previously subjected to saponification treatment with an alkali before being bonded to the polarizer 6 to convert an ester group of cellulose triacetate into a hydroxyl group. The thickness of the polarizing plate 7 in the form of a laminated film is typically from 10 to 100 μm.

### <Others>

The polarizer 6 may also be provided on the surface thereof with a film formed of the other resins. Examples of the film formed of the other resins include a polyethylene terephthalate film, a polycarbonate film, a cyclic polyolefin film, a maleimide-based resin film and a fluorine-based resin film. The film formed of the other resins may be a retardation film exhibiting a specific phase difference.

The polarizing plate may be in the form of a laminated film having at least one hard coat layer in order to enhance surface properties and a mar resistance thereof. The hard coat layer may be formed, for example, from ultraviolet-curing type resins such as ultraviolet-curing type acryl urethanes, ultraviolet-curing type epoxy acrylates, ultraviolet-curing type (poly)ester acrylates and ultraviolet-curing type oxetanes, silicone-based resins, acrylic resins, and urethane-based hard coat agents. Among these hard coat layers, preferred are the hard coat layers formed of the ultraviolet curing type resins from the viewpoints of high transparency, mar resistance and chemical resistance. These hard coat layers may be used alone or in combination of any two or more thereof.

The thickness of the hard coat layer is preferably from 0.1 to 100 μm, more preferably from 1 to 50 μm and still more preferably from 2 to 20 μm. In addition, a primer may be applied between the hard coat layers.

As described above, in the polarizing plate having the optical film obtained according to the production process of the present invention as a polarizer-protective film, the base film disposed on an outside surface of the polarizer formed of polyvinyl alcohol is subjected to easy-bonding treatment. As a result, adhesion between the polarizer formed of polyvinyl alcohol and the polarizer-protective film and peel-resistant durability thereof can be enhanced, so that the obtained polarizing plate can be improved in strength and handling property thereof.

The liquid crystal display device may be constructed by laminating, on both surfaces of a liquid crystal cell including a liquid crystal layer interposed between glass layers, the polarizing plate 7 using the optical film obtained according to the production process of the present invention as shown in FIG. 2 (which is constituted from the base film 3, modified surface layer 2, hydrophilic resin layer 1, polarizer-protective film 4, and polarizer 6) through a tacking adhesive layer 11. The use configuration of the optical film obtained according to the production process of the present invention may vary depending upon the applications thereof. For example, when using the optical film as a protective film for the polarizer on the side of a backlight, the optical film is disposed on an outside surface of the polarizer 6, and the conventional TAC film 5 is disposed on an inside surface of the polarizer 6 as a protective film for protecting the inside surface of the polarizer (in FIG. 2, the lower side is the side of the backlight). When using the optical film obtained according to the production process of the present invention as a retardation film, the optical film is disposed on the side of the polarizer facing the liquid crystal cell, and the TAC film 5 is disposed on the opposite side of the polarizer (FIG. 3).

The materials constituting the liquid crystal layer, the glass layers and the tacking adhesive layer 11 in the liquid crystal cell are not particularly limited, and any known materials may be used for forming these layers. Meanwhile, in the liquid crystal display device, the polarizing plate 7 as shown in FIG. 2 (polarizing plate of the present invention) may be used on the side of one surface of the liquid crystal cell, whereas the other conventional polarizing plate may be used on the side of the other surface of the liquid crystal cell.

In the liquid crystal display device equipped with the polarizing plate in which the optical film obtained according to the production process of the present invention is disposed as the polarizer-protective film, since the polarizer-protective film is subjected to the easy-bonding treatment, adhesion between the polarizer and the polarizer-protective film and peel-resistant durability thereof can be enhanced, and the obtained polarizing plate is excellent in strength and handling property. Therefore, the resulting liquid crystal display device can exhibit various excellent properties for a long period of time in a continuous and stable manner, resulting in high reliability of the apparatus as a whole.

### [Displays]

The optical film obtained according to the production process of the present invention and the polarizing plate using the optical film may be desirably used in various displays.

The optical film obtained according to the production process of the present invention may be used as a retardation film by using the polypropylene resin base film to which a retardation improver is added. The retardation film obtained using a metal salt of a phosphoric acid ester as the retardation improver has positive A-plate characteristic and negative C-plate characteristic and can be used as a polarizer-protective film. Thus, the optical film can be formed as a polarizer-protective film for the polarizing plate having an optical compensation function and can contribute to improvement in simplification of construction of the displays using the polarizing plate as well as productivity thereof.

The displays are not particularly limited, and any displays can be used as long as the polarizing plate is used therein, and the displays are required to exhibit positive A-plate characteristic. Examples of the displays include liquid crystal displays having liquid crystal cells, organic EL displays, and touch panels. In the liquid crystal displays, an image displaying device thereof is generally constituted from liquid crystal cells, an optical film and a drive circuit into which constitutional elements such as an illuminating system are appropriately incorporated according to the requirements. In the present invention, the construction of the image displaying device is not particularly limited except that the above polarizing plate is to be used therein, and it is essentially required that the image displaying device has not only positive A-plat characteristic but also negative C-plat characteristic. For example, there may be used an image displaying device in which the polarizing plate is disposed on one or both sides of the liquid crystal cell, an image displaying device appropriately using a backlight or a reflection plate as an illuminating system, etc. Meanwhile, upon constructing the image displaying device, appropriate parts such as, for example, a diffusion plate, an anti-glare layer, an anti-reflection film, a protective plate, a prism array, a lens array sheet, a light diffusion plate and a backlight may be arranged at appropriate positions in the form of a single layer or two or more multi-layers for each part. In the followings, the liquid crystal display including the liquid crystal cell and the organic EL display are described as exemplary displays.

### <<Liquid Crystal Display Including Liquid Crystal Cell>>

The polarizing plate using the optical film obtained according to the production process of the present invention can be suitably used, for example, by laminating the polarizing plate on a liquid crystal cell, etc. In FIG. 3, there is shown an example of construction of a liquid crystal display (LCD) with a liquid crystal cell in which the polarizing plate is used. In FIG. 3, the optical film obtained according to the production process of the present invention is used not as a polarizer-protective film but as a retardation film. In the liquid crystal display illustrated in FIG. 3, both the retardation film and the polarizer-protective film are used as the constituting elements thereof.

In FIG. 3, reference numeral 8 denotes a liquid crystal cell. Examples of the liquid crystal cell 8 include an active matrix drive type cell such as typically a thin film transistor type cell, and a simple matrix drive type cell such as typically a twist nematic type cell and a super twist nematic type cell. In the construction example shown in FIG. 3, the polarizing plate 7 is laminated on the liquid crystal cell 8 through the tacking adhesive layer 11.

The polarizing plate 7 includes the polarizer 6, and the optical film obtained according to the production process of the present invention is laminated as a retardation film on the surface of the polarizer 6 on its side where the liquid crystal cell is disposed. In addition, on the opposite surface of the polarizer 6, an ordinary TAC film 5 (polarizer-protective film) is laminated. Upon laminating the polarizing plate 7 and the liquid crystal cell 8, the tacking adhesive layer 11 may be previously provided on the polarizing plate 7 and/or the liquid crystal cell 8.

The tacking adhesive used for laminating the polarizing plate and the liquid crystal cell is not particularly limited. For example, acryl-based adhesives are preferably used as the tacking adhesive because they exhibit an excellent optical transparency, and adequate wettability, aggregating property and tacking property such as adhesion property, and are excellent in weather resistance, heat resistance and the like.

Thus, the above tacking adhesive is required to have excellent optical transparency, and adequate wettability, aggregating property and tacking property such as adhesion property, and further exhibit an excellent weather resistance and heat resistance. In addition, in order to prevent occurrence of foaming or peeling phenomenon owing to moisture absorption, and deterioration of optical properties or warpage of liquid crystal cells owing to difference in thermal expansion, and further in order to provide an image displaying device having a high quality and an excellent durability, the tacking adhesive layer is required to have a low moisture absorptivity and an excellent heat resistance.

As the method of applying the tacking adhesive onto the polarizing plate, there may be used, for example, the method in which a base polymer or its composition is dissolved or dispersed in a single solvent or a mixed solvent appropriately selected from toluene, ethyl acetate and the like to prepare a tacking adhesive solution having a concentration of from about 10 to about 40% by mass, and then the thus prepared tacking adhesive solution is directly applied on the polarizing plate by a coating method such as gravure coating, bar coating and roll coating or by an adequate spreading method such as casting, or the modified method thereof in which the tacking adhesive layer is formed on a releasable base film, and then transferred onto the polarizing plate.

The tacking adhesive layer 11 may be in the form of a laminate of plural overlapped layers which are different in composition or kind thereof from each other, and may be provided on one or both surfaces of the polarizing plate. When providing the tacking adhesive layer on both surfaces of the polarizing plate, it is not necessary that the tacking adhesive layers thus formed on the front and rear surfaces of the polarizing plate, respectively, are identical in composition or thickness to each other, i.e., the tacking adhesive layers may be different in compositions and thicknesses from each other.

The thickness of the tacking adhesive layer 11 may be appropriately determined according to objects upon use, adhesion force required, etc., and is generally from 1 to 500 μm, preferably from 5 to 200 μm and especially preferably from 10 to 100 μm.

The exposed surface of the tacking adhesive layer 11 is preferably temporarily covered with a release film prepared by coating a suitable thin sheet such as a plastic film with a proper releasing agent such as silicone-based resins, if required, in order to prevent contamination of the exposed surface before used practically. Thus, the tacking adhesive layer 11 can be effectively inhibited from contacting with any other materials as far as it is handled in an ordinary manner.

### <<Organic EL Display>>

The polarizing plate produced using the optical film obtained according to the production process of the present invention can also be suitably applied to an organic EL display. In general, the organic EL display includes a transparent base plate, and a transparent electrode, an organic luminescent layer and a metal electrode which are successively laminated on the transparent base plate, to thereby form an illuminant (organic electroluminescent member).

In the thus constructed organic EL display, the organic luminescent layer is in the form of a very thin film having a thickness as small as about 10 nm. For this reason, the organic luminescent layer allows light to almost completely penetrate therethrough similarly to the transparent electrode. As a result, upon non-illumination of the organic EL display, light enters from a surface of the transparent base plate and then penetrates through the transparent electrode and the organic luminescent layer, and further is reflected on the metal electrode. The reflected light is emitted again on the side of the surface of the transparent base plate, so that a display surface of the organic EL display looks like a mirror surface as viewed from outside.

In the organic EL display including the organic electroluminescent member constructed from the organic luminescent layer capable of emitting light by application of electric voltage, the transparent electrode disposed on the front surface side of the organic luminescent layer, and the metal electrode disposed on the rear surface side of the organic luminescent layer, the polarizing plate may be provided on the surface of the transparent electrode, and a birefringence layer (retardation film) may be provided between the transparent electrode and the polarizing plate.

The polarizing plate has a function of polarizing the light which enters from outside and is reflected on the metal electrode. Owing to the above polarizing function, the polarizing plate exhibits such an effect that the mirror surface of the metal electrode is not visually recognized from outside. In particular, when using the retardation film according to the present invention to exhibit only a function as a positive A-plate, the retardation film is constructed as a λ/4 plate, and the angle between polarizing directions of the polarizing plate and the birefringence layer is adjusted to π/4, so that the mirror surface of the metal electrode can be completely shielded from outside. The optical film obtained according to the production process of the present invention may serve as a retardation film by adding a retardation improver thereto, and therefore can be used as the above retardation film for the purpose of shielding the mirror surface of the metal electrode from outside.

More specifically, with respect to light coming from outside and entering into the organic EL display, only a linearly polarized component thereof can penetrate through the polarizing plate. The linearly polarized light is generally converted into an elliptically polarized light when penetrating through the retardation film. However, when the retardation film is in the form of a λ/4 plate and the angle between polarizing directions of the retardation film and the polarizing plate is π/4, the light is converted into a circularly polarized light when penetrating through the retardation film. The circularly polarized light successively penetrates through the transparent base plate, the transparent electrode and the organic thin film, is reflected on the metal electrode, and then penetrates again through the organic thin film, the transparent electrode and the transparent base plate and further through the retardation film whereby the circularly polarized light is converted again into the linearly polarized light. The direction of the linearly polarized light is perpendicular to the polarizing direction of the polarizing plate and therefore is unable to penetrate through the polarizing plate. As a result, it is possible to completely shield the mirror surface of the metal electrode from outside.

An ordinary TAC film 5 as a polarizer-protective film may be laminated on the surface of the polarizer 6 on which no polarizer-protective film 4 is laminated, by a similar method, to thereby produce the polarizing plate 7. The TAC film 5 may be previously subjected to saponification treatment with an alkali before bonded to the polarizer 6 to convert an ester group of cellulose triacetate into a hydroxyl group. The thickness of the thus laminated polarizing plate 7 is typically not less than 10 μm and not more than 100 μm.

As described above, in the polarizing plate including the optical film obtained according to the production process of the present invention as a polarizer-protective film, since the base film to be disposed on an outside surface of the polarizer formed of polyvinyl alcohol is subjected to easy-bonding treatment, adhesion between the polarizer formed of polyvinyl alcohol and the polarizer-protective film and a peel-resistant durability thereof can be enhanced, so that the polarizing plate can be improved in strength and handling property.

### EXAMPLES

The present invention will be described in more detail by referring to the following examples. However, it should be noted that these examples are only illustrative and not intended to limit the invention thereto.

### <Process for Producing Polypropylene Resin Base Film>

### (Base Film A)

One (1.0) part by mass of a benzotriazole-based UV absorber (available from BASF) was compounded in 100 parts by mass of polypropylene (“WINTEC (registered trademark)” available from Japan Polypropylene Corp.; melting point: 142° C.; flexural modulus: 900 MPa; hereinafter referred to merely as “mPP-A”) produced by polymerization using a metallocene catalyst, and the resulting mixture was heated and melted. The thus molten resin was subjected to T: die single layer extrusion molding at a molding temperature of 210° C. and a take-up roll temperature of 50° C. such that a film extruded had a thickness of 80 μm to thereby obtain a base film A (in-plane retardation Re: 5 nm). Next, the surface of the thus obtained base film A was subjected to high-voltage corona discharge treatment using a high-voltage corona discharge treatment device to thereby adjust a wetting index of the base film to 50 mN/m. Meanwhile, the film obtained above was subjected to no stretching treatment after the molding.

### (Base Film B)

One part by mass of a cyclic phosphoric acid ester lithium salt (“ADEKASTAB (registered trademark) NA-Series” available from Adeka Corp.) as a phosphoric acid ester metal salt-based retardation improver was compounded in 100 parts by mass of polypropylene (“WINTEC (registered trademark)” available from Japan Polypropylene Corp.; melting point: 142° C.; flexural modulus: 900 MPa; hereinafter referred to merely as “mPP-A”) produced by polymerization using a metallocene catalyst, and the resulting mixture was heated and melted. The thus molten resin was subjected to T-die single layer extrusion molding at a molding temperature of 210° C. and a take-up roll temperature of 50° C. such that a film extruded had a thickness of 100 μm to thereby obtain a base film B for VA-mode (in-plane retardation Re: 75 nm; retardation in thickness direction Rth: 105 nm). Next, the surface of the thus obtained base film A was subjected to high-voltage corona discharge treatment using a high-voltage corona discharge treatment device to thereby adjust a wetting index of the base film to 50 mN/m. Meanwhile, the film obtained above was subjected to no stretching treatment after the molding.

### <Production of Hydrophilic Resin Layer>

### (Production of Acrylic Resin-Containing Hydrophilic Resin Composition)

Thirty parts by mass of a copolymer produced from 70% by mass of 2-hydroxyethyl acrylate and 30% by mass of methyl acrylate, 2.5 parts by mass of neopentyl glycol hydroxypivalate diacrylate, 3 parts by mass of a urethane acrylate-based oligomer (“BEAMSET 500” available from Arakawa Chemical Industries Ltd.), 3 parts by mass of a silicone-based surfactant, and 50 parts by mass of water were blended with each other to thereby prepare an acrylic resin-containing hydrophilic resin composition (aqueous emulsion).

### (Production of Urethane Resin-Containing Hydrophilic Resin Composition)

Twenty five parts by mass of a polyester-based aqueous urethane having a solid content of 40% by mass (“HYDRAN HW-333” (tradename) available DIC Corp.), 25 parts by mass of a 10% PVA aqueous solution, 5 parts by mass of hydroxyethyl methacrylate, and 45 parts by mass of water were blended with each other and reacted in a reaction vessel maintained at about 70° C. for a predetermined time to thereby prepare an urethane resin-containing hydrophilic resin composition (aqueous emulsion).

### (Production of Polarizer)

A 200 μm-thick PVA film was subjected to monoaxial stretching (at a temperature of 110° and stretch ratio of 5 times) to obtain a film having a thickness of 40 μm. The thus obtained film was immersed in an aqueous solution containing 0.15 g of iodine and 10 g of potassium iodide for 60 s and then immersed in an aqueous solution containing 12 g of potassium iodide and 7.5 g of boric acid at 68° C. The thus treated film was washed with water and then dried, thereby obtaining a PVA polarizer film.

### Example 1

The acrylic resin-containing hydrophilic resin composition was applied (coating thickness: 0.2 μm) on the base film A and then dried at 140° C. to obtain an optical film. Next, the thus obtained optical film as a polarizer-protective film was cut into A4 size (295 mm×210 mm), and the PVA polarizer film cut into the same size was laminated on the polarizer-protective film through an adhesive (a PVA aqueous solution having a solid content of 2.5% by mass). In addition, a TAC film (“FUJITACK” (product name) available from Fuji Film Corp.) was laminated onto a surface of the PVA polarizer film opposed to its surface on which the polarizer-protective film was laminated, through an adhesive (a PVA aqueous solution having a solid content of 2.5% by mass), thereby obtaining a polarizing plate sample.

### Examples 2 to 4

The same procedure as in Example 1 was repeated except that the base film and the hydrophilic resin composition were changed to those shown in Table 1, thereby obtaining polarizing plate samples.

### Comparative Example 1

The same procedure as in Example 1 was repeated except that no hydrophilic resin composition was applied onto the base film A, and therefore no hydrophilic resin layer was formed thereon, thereby obtaining a polarizing plate sample.

### Comparative Example 2

The same procedure as in Example 3 was repeated except that the base film A used therein was subjected to no high-voltage corona discharge treatment, thereby obtaining a polarizing plate sample.

The polarizing plate samples obtained in Examples 1 to 4 and Comparative Examples 1 and 2 were subjected to the following evaluations for their appearance.

(1) Examination of Condition of Polarizing Plate Immediately After Laminated (Evaluation for Initial Adhesion Property)

The polarizing plate samples obtained in the respective Examples and Comparative Examples were cut at a central portion thereof into a size of 10 cm square using a cutter to prepare test samples. The respective test samples were subjected to observation of an appearance thereof at room temperature to examine an adhesion property thereof. The observation results were evaluated according to the following ratings.

A: Good appearance, and no problem concerning adhesion property.

B: No defective floating of base material occurred, but very slight peeling occurred at a part of end portions.

C: No problem concerning appearance, but peeling occurred at a part of end portions.

D: Significant deviation of base material and peeling at end portions occurred (poor adhesion condition).

### (2) Preservation Test (Accelerated Test)

The polarizing plate samples obtained in the respective Examples and Comparative Examples were allowed to stand at 80° C. and 90% RH for 1000 h to observe an appearance thereof and examine an adhesion property thereof. The observation results were evaluated according to the following ratings.

A: Good appearance, and no problem concerning adhesion property.

B: No defective floating of base material occurred, but very slight peeling occurred at a part of end portions.

C: No problem concerning appearance, but peeling occurred at a part of end portions.

D: Significant deviation of base material and peeling of end portions occurred (poor adhesion condition).

TABLE 1

| | | | | | Evaluation |
|---|---|---|---|---|---|
| | | | | | of adhesion |
| | | | | Evaluation | property |
| | | | Resin of | of initial | after |
| | Base | Surface | hydrophilic | adhesion | accelerated |
| | film | treatment | resin layer | property | test |
| Example 1 | A | Treated | Acryl | B | B |
| Example 2 | B | Treated | Acryl | B | A |
| Example 3 | A | Treated | Urethane | A | A |
| Example 4 | B | Treated | Urethane | A | A |
| Comparative | A | Treated | — | D | D |
| Example 1 | | | | | |
| Comparative | A | Untreated | Urethane | C | D |
| Example 2 | | | | | |

From the results shown in Table 1, it was confirmed that the polarizing plate samples obtained in Examples 1 to 4 exhibited a good initial adhesion property and were excellent in durability even under high-temperature conditions. In particular, it was confirmed that the polarizing plate samples obtained in Examples 3 and 4 in which the urethane resin was used as the hydrophilic resin were very excellent in not only initial adhesion property but also durability under high-temperature conditions.

On the other hand, from the evaluation results of Comparative Example 1, it was confirmed that even though the base film was subjected to physical surface treatment, if no hydrophilic resin layer was provided, the resulting film failed to exhibit a sufficient adhesion property to the PVA polarizer film. In addition, from the evaluation results of Comparative Example 2, it was confirmed that even though the hydrophilic resin layer was provided, if only the physical surface treatment was conducted, the resulting film failed to exhibit a sufficient adhesion property to the PVA polarizer film.

As described hereinabove, it was confirmed that when subjecting the polypropylene resin base film to physical surface treatment to provide a modified surface thereon and further forming the hydrophilic resin layer on the modified surface, the optical film thus obtained according to the production process of the present invention exhibited an excellent adhesion property to the PVA polarizer film as well as a good high-temperature durability.

1. A process for producing an optical film, comprises the following steps (1) and (2):
Step (1): subjecting at least one surface of a polypropylene resin base film to physical surface treatment; and
Step (2): applying a hydrophilic resin composition onto the physically treated surface of the polypropylene resin base film.

2. The process for producing an optical film according to claim 1, wherein the physical surface treatment is at least one treatment selected from the group consisting of corona discharge treatment, high-voltage corona treatment, glow discharge treatment, ultraviolet irradiation treatment and plasma treatment.

3. The process for producing an optical film according to claim 1, wherein a hydrophilic resin contained in the hydrophilic resin composition is at least one resin selected from the group consisting of an acrylic resin, a urethane resin, a polyester resin and an epoxy resin.

4. The process for producing an optical film according to claim 1, wherein a polypropylene resin composition constituting the polypropylene resin base film contains a polypropylene produced by polymerization using a metallocene catalyst.

5. The process for producing an optical film according to claim 1, wherein the optical film is subjected to no stretching treatment.

6. The process for producing an optical film according to claim 2, wherein a hydrophilic resin contained in the hydrophilic resin composition is at least one resin selected from the group consisting of an acrylic resin, a urethane resin, a polyester resin and an epoxy resin.

7. The process for producing an optical film according to claim 6, wherein a polypropylene resin composition constituting the polypropylene resin base film contains a polypropylene produced by polymerization using a metallocene catalyst.

8. The process for producing an optical film according to claim 3, wherein a polypropylene resin composition constituting the polypropylene resin base film contains a polypropylene produced by polymerization using a metallocene catalyst.
